(19) United States
(12) Patent Application Publication
(10) Pub. No.: US 2007/0073612 A1
(43) Pub. Date: Mar. 29, 2007

(54) Method, system, and computer program product for providing credit services

(76) Inventors: Jonathan Smith, Ladera Ranch, CA (US); Mary-Angela Trammell, Rancho Santa Margarita, CA (US); Thomas Dovel, Centerville, OH (US); Lori Momsen, Centerville, OH (US); Brian Post, Rancho Santa Margarita, CA (US); Tony Seymour, Rancho Palos Verdes, CA (US)

Correspondence Address: CANTOR COLBURN, LLP, 55 GRIFFIN ROAD SOUTH, BLOOMFIELD, CT, 06002, US

(21) Appl. No.: 11/234,288

(22) Filed: Sep. 23, 2005

(51) Int. Cl. G06Q 40/00

(52) U.S. Cl. 705/38

(57) ABSTRACT

A method, system, and computer program product for providing credit services is provided. The method includes establishing a first and second minimum levels of eligibility for a first and second set of financing options, respectively. The second set of financing options includes additional credit offer terms for mitigating risk. In response to receiving a request for a financing arrangement that includes the first set of financing options, the method includes performing an eligibility determination for a requester to ascertain which of the minimum levels of eligibility, if any, applies to the requester, and providing a response to the requester based upon results of the eligibility determination. The response includes one of: approving the request for the financing arrangement that includes the first set of financing options, offering the requester other financing arrangement that includes the second set of financing options, and declining the request.

### BACKGROUND

The present disclosure relates generally to credit services, and in particular, to a method, system, and computer program product for providing credit services.

Merchants offer their customers financing, provided by a financial institution (“bank”) primarily to make a large dollar purchase more attractive by allowing the customer to either pay over time with a relatively low interest or by paying over time with deferred interest for a specified period of time. Offering financing can attract more customers and convert more customers into a buying decision. The financing vehicle is typically a revolving account with a set maximum credit line but can include closed end secured and non-secured loans.

Private label financing has varying approval rates for customer financing, mostly depending on the demographics, or creditworthiness, the retailer attracts. In retail, while having as high of an approval rate as possible to maximize sales is desired, application declines are understood as part of doing business. Simply put, retailers desire the highest approval rate with the highest credit line assignments possible.

Having offered financing as an option, retailers simply do not want to deliver the bad news of a decline. This is especially true in the healthcare market. Because of the special doctor-customer relationship healthcare providers especially fear an application for a patient, their customer, will be declined. This fear causes the merchants to limit offering all of their patients the advantage of the financing option. As a result of this fear, they often only offer financing to their customers as a last resort. Because they are offering financing to those customers as a last resort, perhaps to those who have no other way to pay, and as a result have, on average, a lower creditworthiness score, the odds of having a declined credit application is made higher. This fear, resulting in offering only as a last resort, runs in the face of the very reason why a merchant would offer financing in the first place (i.e., to attract and convert more customers into a buying decision).

The lender typically sets credit approval criteria, or cutoffs, down to where on average the lowest credit score it approves will not be profitable (where the average losses of that credit score create no profit). An approval under the cutoff would mean on average net losses. The lender can use various risk mitigants to improve losses, such as custom credit scoring models and various promotional terms. But there is a limit to the percentage of applications that can be approved, especially with unsecured revolving credit. Typical approval rates vary dramatically depending on industry and the demographics of customer attracted to the business in that industry.

A customer who is approved for credit may on occasion fail to manage or fail to remit monthly payments. This causes late fees and finance fees to be charged to the customer by the lender and may also cause negative reporting to the credit bureau.

Credit line assignment models, used by lenders, are also used to limit risk exposure where, even if approved, the riskier approved applications may be assigned a lower credit line. This creates a problem for the customer and the merchant if the credit line is not high enough to cover the treatment cost and can result in the customer declining the service or product, and perhaps shopping elsewhere.

Without the use of credit, many customers will not accept the product or service. This is especially true in healthcare where a patient may be recommended a higher cost, non-insured treatment they did not expect.

Various solutions have been developed in an attempt to overcome the disadvantages laid out above, however, none have been successful. What is needed, therefore, is a way to provide the ability to offer financing to the greatest number of borrowers while minimizing the level of risk of losses associated with financing plans.

### BRIEF SUMMARY

A method, system, and computer program product for providing credit services is provided. The method includes establishing first and second minimum levels of eligibility for a first and second set of financing options, respectively. The second set of financing options includes terms for mitigating risk. In response to receiving a request for a financing arrangement that includes the first set of financing options, the method includes performing an eligibility determination for a requester to ascertain which of the minimum levels of eligibility, if any, applies to the requester, and providing a response to the requester based upon results of the eligibility determination. The response includes one of: approving the request for the financing arrangement that includes the first set of financing options, offering the requester other financing arrangement that includes the second set of financing options, and declining the request.

The system for providing credit services includes a host system in communication with at least one provider entity over a network and a credit application executing on the host system. The credit application performs a method. The method includes establishing a first minimum level of eligibility for a first set of financing options. The method also includes establishing a second minimum level of eligibility for a second set of financing options, the second minimum level of eligibility correlated to a risk that is higher than that of the first minimum level of eligibility. The second set of financing options includes terms for mitigating risk.

In response to receiving a request from the at least one provider entity for a financing arrangement that includes the first set of financing options, the method includes performing an eligibility determination for a requester to ascertain which of the minimum levels of eligibility, if any, applies to the requester and providing a response to the requester via the at least one provider entity based upon results of the eligibility determination. The response includes one of: approving the request for the financing arrangement that includes the first set of financing options, offering the requester other financing arrangement that includes the second set of financing options, and declining the request.

The computer program product for providing credit services includes instructions for executing a method. The method includes establishing first and second minimum levels of eligibility for a first and second set of financing options, respectively. The second set of financing options includes terms for mitigating risk. In response to receiving a request for a financing arrangement that includes the first set of financing options, the method includes performing an eligibility determination for a requester to ascertain which of the minimum levels of eligibility, if any, applies to the requester, and providing a response to the requester based upon results of the eligibility determination. The response includes one of: approving the request for the financing arrangement that includes the first set of financing options, offering the requester other financing arrangement that includes the second set of financing options, and declining the request.

### BRIEF DESCRIPTION OF THE DRAWINGS

Referring to the exemplary drawings wherein like elements are numbered alike in the accompanying FIGURES:

FIG. 1 is a block diagram of a system upon which the credit services may be implemented in exemplary embodiments;

FIG. 2 is a flow diagram describing a process for implementing the credit services in exemplary embodiments; and

FIG. 3 is a user interface screen as seen by a provider for use in implementing the credit services in exemplary embodiments.

### DETAILED DESCRIPTION OF EXEMPLARY EMBODIMENTS

In accordance with exemplary embodiments, credit services are provided for facilitating financing plans between customers of merchant provider entities and various lending institutions. The credit services enable merchant provider entities to extend financing options to a greatest possible number of qualified customers who desire to purchase high cost goods and/or services from the merchant providers. The credit services also provide a multi-level screening process in order to qualify the greatest number of customers for financing while safeguarding against losses resulting from financing arrangements that are determined to be at high risk. If qualified at the first level screening, the customer is immediately notified and approved for a financing plan that is designed for low risk customers. The second level screening, if implemented, may occur unbeknownst to the customers, thereby avoiding any embarrassment or discomfort otherwise associated with delivering unfavorable screening results. If qualified at the second level screening, the customer is offered a financing arrangement, the terms of which are designed to compensate for any increase in the credit risk identified for the customer. Possible methods to compensate for the increase in risk include, but are not limited to, one or more of, requiring a down payment from the customer, requiring the customer to allow for automatic monthly withdrawal from their checking account for repayment, either via electronic funds transfer (EFT) or automatic generation of monthly drafts through means other than EFT, promotional terms that require faster payoff of total amount financed, higher merchant discount, and higher fees or finance charged to the customer. The credit services further provide the ability to set up and execute the financing plans, including notifying the lending and borrower institutions of the financing plan.

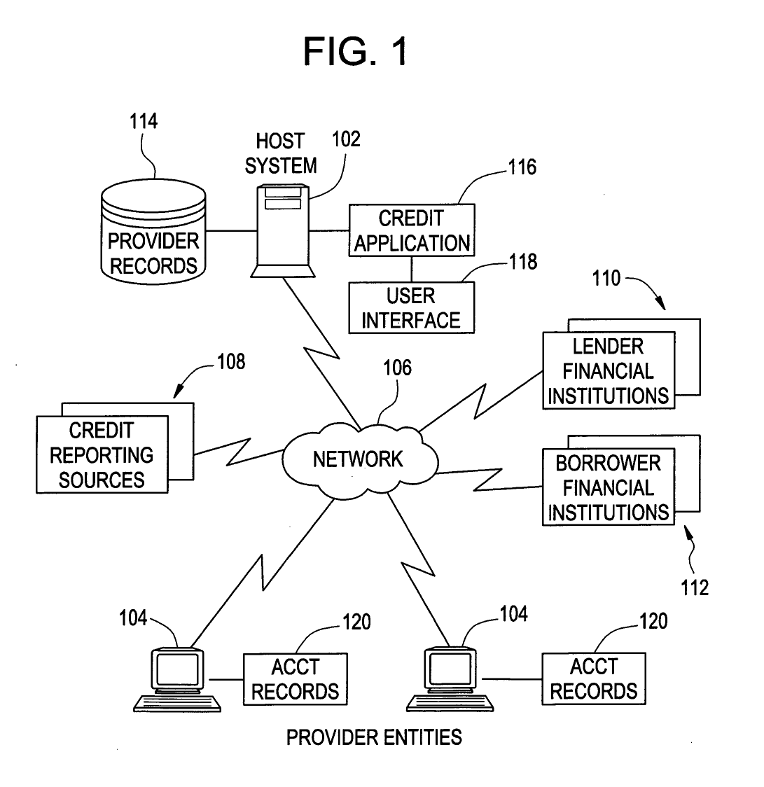

Turning now to FIG. 1, a system upon which the credit services may be implemented in accordance with exemplary embodiments will now be described. The system of FIG. 1 includes a host system 102 executing computer instructions for providing credit services. The host system 102 is in communication with provider entities 104 over a network 106. The host system 102 may be an enterprise that offers credit management services to various provider entities under an agreement. For example, host system 102 may be an application service provider (ASP) or other third-party entity that offers these services. A merchant provider entity (provider entity) refers to an entity that provides products and/or services to customers (also referred to as “borrowers” and “requesters”) for a fee. The provider entity may be a retail establishment, a network-based vendor, a medical establishment, or any other suitable enterprise that offers products and/or services.

The provider entities 104 may include one or more computer systems through which users at one or more geographic locations may contact the host system 102. Each provider entity 104 may be implemented using a general-purpose computer executing a computer program for carrying out the processes described herein. The provider entities 104 may be personal computers (e.g., a lap top, a personal digital assistant) or host attached terminals. If the provider entities 104 are personal computers, the processing described herein may be shared by the provider entities 104 and the host system 102 (e.g., by providing an applet to the provider entities 104). The provider entities 104 store account records 120 for their respective customers which may be used to track customer expenditures, historical records of financing activities, and other relevant information.

The network 106 may be any type of known network including, but not limited to, a wide area network (WAN), a local area network (LAN), a global network (e.g. Internet), a virtual private network (VPN), and an intranet. The network 106 may be implemented using a wireless network or any kind of physical network implementation known in the art. A provider entity 104 may be coupled to the host system 102 through multiple networks (e.g., intranet and Internet) so that not all provider entities 104 are coupled to the host system 102 through the same network. One or more of the provider entities 104 and the host system 102 may be connected to the network 106 in a wireless fashion. In one embodiment, the network 106 is an intranet and one or more provider entities 104 execute a user interface application (e.g. a web browser) to contact the host system 102 through the network 106. In another exemplary embodiment, the provider entity 104 is connected directly (i.e., not through the network 106) to the host system 102 and the host system 102 is connected directly to or contains a storage device 114.

The storage device 114 includes data relating to provider entities serviced by the host system 102 and may be implemented using a variety of devices for storing electronic information. It is understood that the storage device 114 may be implemented using memory contained in the host system 102 or it may be a separate physical device as shown in FIG. 1. The storage device 114 is logically addressable as a consolidated data source across a distributed environment that includes a network 106. Information stored in the storage device 114 may be retrieved and manipulated via the host system 102 and/or via the provider entities 104. A data repository containing provider records or accounts is located on the storage device 114.

In exemplary embodiments, the host system 102 operates as a database server and coordinates access to application data including data stored on the storage device 114.

The host system 102 communicates with network entities, such as credit reporting sources 108, lender financial institutions 110, and borrower financial institutions 112, in addition to the provider entities 104, over network 106. Credit reporting sources 108 provide details of a customer's financial history, such as previous and outstanding debts to other creditors, ability to repay debt as evidenced by demonstrated continuity of payments to creditors (e.g., lack of credit default activities), and other information that provides insight as to the customer's potential risk. Credit reporting sources 108 may include credit bureaus or agencies. The credit application 116 communicates with the credit reporting sources 108 as described further herein.

Financial institutions 10 and 112 may include banks, credit unions, or other enterprise that provides financial resources to its customers. Lender financial institutions 110 provide financing to customers of the provider entities 104 as described further herein. Borrower financial institutions 112 refer to institutions that provide account services to customers of provider entities 104, such as checking, savings, debit, credit, and other services. In exemplary embodiments, the customers of providing entities 104 hold accounts with one or more of borrower financial institutions 112 that, in turn, provides electronic funds transfer (EFT) services for its customers. The borrower financial institutions 112 may also provide to the host system 102 information regarding the customers' accounts (also referred to as requesters' accounts) including status of account, e.g., account open or closed, account had a positive balance, account has outstanding drafts with insufficient funds.

The host system 102 depicted in FIG. 1 may be implemented using one or more servers operating in response to a computer program stored in a storage medium accessible by the server. The host system 102 may operate as a network server (e.g., a web server) to communicate with the network entities. The host system 102 handles sending and receiving information to and from the network entities and can perform associated tasks. The host system 102 may also include a firewall to prevent unauthorized access to the host system 102 and enforce any limitations on authorized access. For instance, an administrator may have access to the entire system and have authority to modify portions of the system. A firewall may be implemented using conventional hardware and/or software as is known in the art.

The host system 102 may also operate as an application server. The host system 102 executes one or more computer programs (e.g., credit application 116) to provide credit services to provider entities 104 and its customers. The credit application 116 may further include a user interface 118 that is accessible to the provider entities 104 as described further herein. Processing may be shared by the provider entities 104 and the host system 102 by providing an application (e.g., java applet) to the provider entities 104. Alternatively, the provider entities 104 may include stand-alone software applications for performing a portion or all of the processing described herein. Alternatively, customers may interface directly into the host system 102 through their own computer system (not shown), or other device, submitting the credit application directly and receiving the approval response directly. As previously described, it is understood that separate servers may be utilized to implement the network server functions and the application server functions. Alternatively, the network server, the firewall, and the application server may be implemented by a single server executing computer programs to perform the requisite functions.

As described above, the credit services include a multi-level screening process for evaluating credit worthiness of customers and determining suitable financing options to offer customers. The credit application 116 is configured such that a first level of screening is performed before a determination is made whether to proceed with a second level of screening. This may be accomplished by establishing a minimum level of eligibility for determining low risk customers. This minimum level of eligibility is associated with a defined set of financing options. For example, a low risk customer may be offered a set of financing options that includes one or more of: no interest financing, low interest financing, extended payment plan, an installment plan, a revolving line of credit, no down payment, etc. The minimum level of eligibility may be determined based upon, e.g., a customer's credit score as determined by a credit bureau or other entity, demographic information of the provider entity location (e.g., level of financial risk known for a population served by the provider entity or surrounding area), the cost of the product or service for which financing is requested, and/or other suitable criteria.

A second minimum level of eligibility may then be established and associated with a second set of financing options. For example, a customer who does not qualify for first level of financing options, but who qualifies under the second minimum level of eligibility may be offered financing options that include, one or more of: a minimum down payment, a limited term payment plan, an interest rate higher than that of the first financing plan (e.g., an interest rate set in order to mitigate the higher risk), required automatic EFT payments from the customer's account (i.e., provided through the borrower financial institution 112), and a payment plan that requires payments to be made by automatic generation of monthly drafts through means other than EFT. The combination of these additional options, associated with second level of financing, allows for a dramatically higher percentage of approved applications.

While the second set of financing options may offer terms that are somewhat more restrictive than those offered for what are considered to be ‘lower risk’ customers, the second set of financing options may be designed to provide terms that are more attractive to customers than those offered under traditional subprime programs. For example, the provider entities 104 may be charged a higher discount fee than what is typically charged under existing lending programs. This higher discount fee provides some mitigation to anticipated risks associated with providing financing to higher risk customers. Though incurring a greater discount fee, merchants are relieved of the trepidation or concerns associated with delivering news of rejection to their valued customers. With this fear eliminated or minimized, the merchants may be more inclined to extend financing offers to more of their customers, which in turn, may lead to more customers applying for financing (including more low risk customers), ultimately resulting in the potential for more generated business for both the merchants (provider entities) and lender financing institutions.

While only two levels of eligibility are described, it will be understood that any number of additional levels of eligibility may be established in order to realize the advantages of the exemplary embodiments. For example, a second level may require 10% down payment and EFT payments and a third level of eligibility may require a 20% down payment, 12 month repayment, and a 10% merchant discount fee. Once the levels of eligibility are established and associated with levels of financing options, requests for financing through the credit application 116 may be implemented.

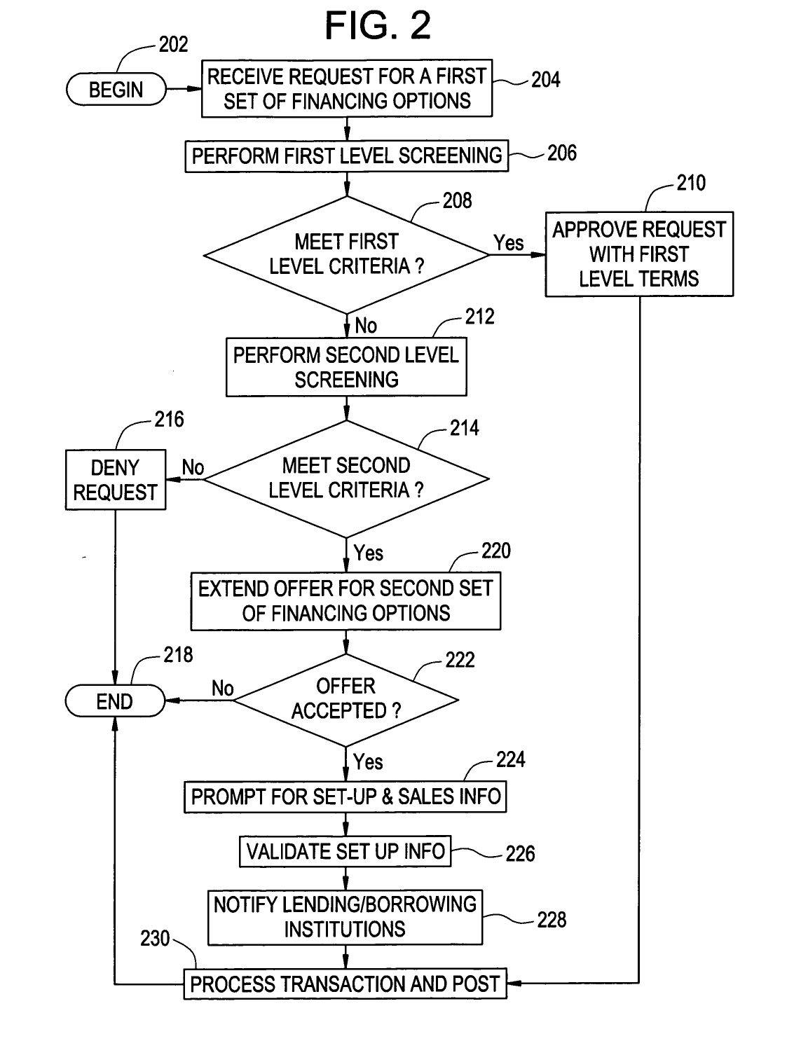

Turning now to FIG. 2, a process for implementing the credit services will now be described in accordance with exemplary embodiments. The process begins at step 202 when a borrower initiates a request for a first set of financing options. The request includes identification information of the borrower (e.g., name, social security number, date of birth, etc.) as well as the requested amount to be financed. The request is received by the host system 102 at step 204. The credit application 116 initiates a first level screening for the borrower at step 206. The first level screening is performed in order to determine whether the borrower meets the minimum level criteria established in order to be eligible to receive the first set of financing options. The screening may include assessing the borrower's credit worthiness based upon, e.g., a credit scoring system, or other suitable means of determining credit worthiness. Credit worthiness determinations may also factor in criteria that is not specific to the borrower but is generally relevant or useful in supplementing the credit worthiness evaluation. For example, demographic information associated with a provider entity may be considered (e.g., provider entity is located in a geographic location that has a high percentage of population at or near the poverty level).

At step 208, it is determined whether the borrower meets the minimum level criteria for the first set of financing options. If so, the credit application 116 sends an approval notice to the provider entity 104 associated with the borrower, along with the specific terms of the first level financing at step 210.

If, on the other hand, the borrower does not meet the minimum level criteria for the first set of financing options, the credit application 116 automatically initiates a second level screening for the borrower at step 212. This second level of screening may be unbeknownst to the borrower. The second level screening is performed in order to determine whether the borrower meets the minimum level criteria established in order to be eligible to receive the second set of financing options. The screening may include assessing the borrower's credit worthiness based upon, e.g., a credit scoring system, or other suitable means of determining credit worthiness. Credit worthiness determinations may also factor in criteria that is not specific to the borrower but is generally relevant or useful in supplementing the credit worthiness evaluation.

At step 214, it is determined whether the borrower meets the minimum level criteria for the second set of financing options. The minimum level criteria for the second set of financing options may be established at a threshold that ensures a high rate of approval. For example, the minimum level criteria for the second set of financing options may require that the borrower information exists in a data repository searched by a credit reporting source (e.g., credit bureau), the borrower information reflects that the borrower is not deceased, and that the borrower has not applied for bankruptcy protection. Other criteria that may be considered include, e.g., credit bureau scores, costs of the product or service for which financing is requested, and demographic information. If the borrower does not meet the second level criteria, the credit application 116 issues a notice of denial for the request at step 216, and the process ends at step 218.

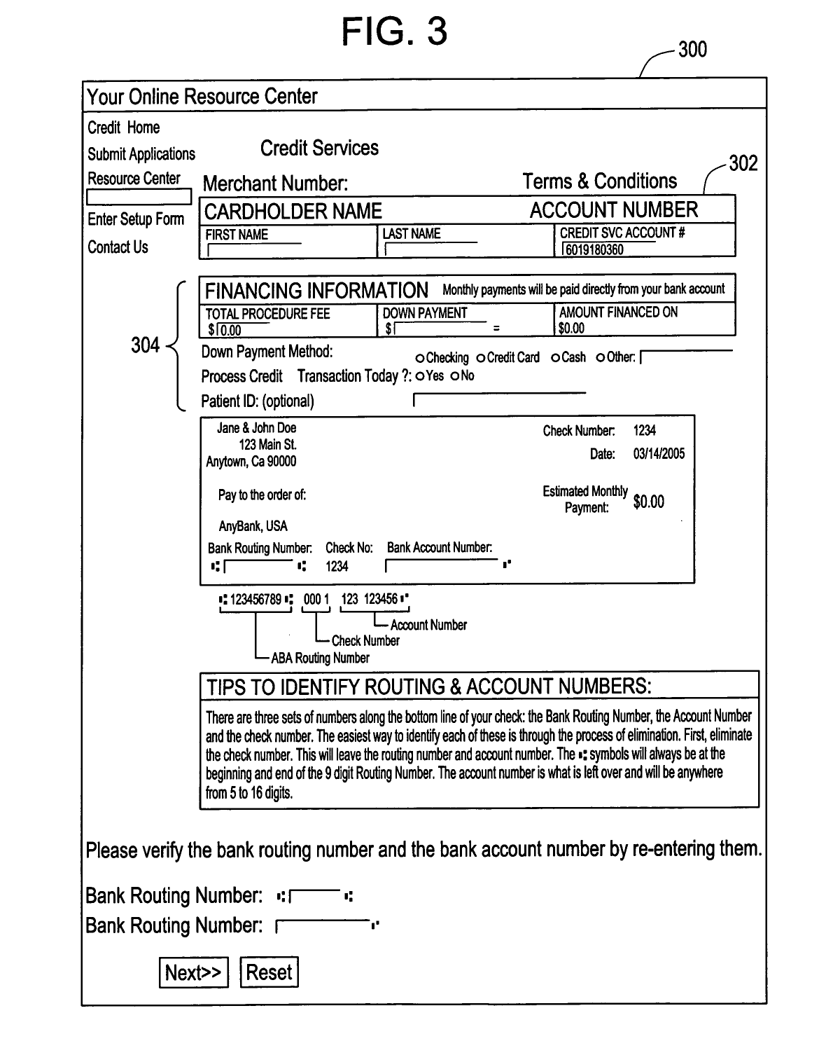

However, if the borrower does meet the second level criteria at step 214, the credit application 116 generates an offer for the second set of financing options and extends the offer to the borrower through the provider entity 104 at step 220. At step 222, it is determined whether the borrower has accepted the offer. If not, the process ends at step 218. Otherwise, the credit application 116 prompts the provider entity 104 to enter borrower information via a set-up form provided by the credit application 116 at step 224. The set-up form may be accessed by the provider entity via the user interface 118 of the credit application 116. A sample user interface screen 300 is shown in FIG. 3.

Turning back to step 210, if the borrower is approved for the first set of financing options, the provider entity 104 notifies financial institution 110 of the transaction amount and promotional terms, through, e.g., a phone system, networked terminal, or other established network interface and the process continues at step 230.

Turning back to step 220, if the borrower accepts the terms of the offer for second set of financing options, the provider entity 104 provides the financial institutions 110, 112 with the necessary information to complete the process. As shown in FIG. 3, the user interface screen 300 enables a provider entity 104 to enter information (e.g., set up process) for a customer who has been approved and has accepted a financing plan. The user interface screen 300 includes a box 302 for providing customer (borrower) information, such as the borrower's name. The box 302 also includes a field that specifies the borrower account number that is uniquely assigned by the credit application 116. A financial information block 304 is also provided in the user interface screen 300. The provider entity 104 enters information relating to the borrower financial institution 112 and information relating to the borrower's account with the financial institution 112. This information enables automatic EFT payments to be made from the customer's account with the institution 112 to the lender financial institution 110 that is providing the financing.

At step 226, the provider entity 104 validates the set-up information. This step may include, e.g., ensuring that customer's account with the borrower financial institution 112 exists, that adequate funds exist in the borrower's account to cover the required down payment, that outstanding drafts with insufficient funds on the account do not exist, and that the information entered during set up is correct. At step 228, the provider entity 104 notifies the lending institutions and/or borrowing institutions of the financing agreement. The notification may be generated by the credit application 116 and transmitted to the institutions 110, 112. The transaction is processed (e.g., EFT funds initiated) and posted at step 230 and the process ends at step 218.

As described above, the embodiments of the invention may be embodied in the form of computer-implemented processes and apparatuses for practicing those processes. Embodiments of the invention may also be embodied in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. The present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits. The technical effect of the executable code is to provide credit services to customers of provider entities.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A method for providing credit services, comprising:
establishing a first minimum level of eligibility for a first set of financing options;
establishing a second minimum level of eligibility for a second set of financing options, the second minimum level of eligibility correlated to a risk that is higher than that of the first minimum level of eligibility, the second set of financing options including terms for mitigating risk;
in response to receiving a request for a financing arrangement that includes the first set of financing options, performing an eligibility determination for a requester to ascertain which of the minimum levels of eligibility, if any, applies to the requester; and
providing a response to the requester based upon results of the eligibility determination that includes one of:
approving the request for the financing arrangement that includes the first set of financing options;
offering the requester an other financing arrangement that includes the second set of financing options; and
declining the request.

2. The method of claim 1, further comprising:
in response to receiving an acceptance from the requester of one of the financing arrangement that includes the first set of financing options and the other financing arrangement that includes the second set of financing options:
verifying that an account with a borrower institution exists for the requester;
verifying that adequate funds exist in the account to cover a down payment;
verifying that outstanding drafts with insufficient funds on the account do not exist;
verifying that checking account information entered during setup is correct; and
notifying a lending institution providing the financing arrangement of the terms of the financing arrangement.

3. The method of claim 1, wherein the first set of financing options includes at least one of:
a revolving line of credit;
an installment repayment plan;
a no interest payment plan;
a low interest payment plan;
no down payment; and
an extended payment plan.

4. The method of claim 1, wherein the second set of financing options includes at least one of:
a minimum down payment;
a limited term payment plan;
an interest rate that is higher than an interest rate offered for the first set of financing options;
a payment plan that requires payments made by automatic electronic funds transfer; and
a payment plan that requires payments made by automatic generation of monthly drafts through means other than electronic funds transfer.

5. The method of claim 1, wherein the eligibility determination is based upon at least one of:
credit bureau score;
a cost of a product or service for which financing is requested; and
demographic information.

6. The method of claim 1, wherein the request is declined upon a determination of at least one of:
credit bureau score;
a cost of a product or service for which financing is requested;
demographic information.
the eligibility determination indicates the requester is deceased;
no financial information is found for the requester; and
the requester has filed for bankruptcy.

7. The method of claim 1, wherein the performing an eligibility determination includes performing a second level screening if the requester is not eligible for the first set of financing options upon completion of a first level screening.

8. A system for providing credit services, comprising:
a host system in communication with at least one provider entity over a network;
a credit application executing on the host system, the credit application performing:
establishing a first minimum level of eligibility for a first set of financing options;
establishing a second minimum level of eligibility for a second set of financing options, the second minimum level of eligibility correlated to a risk that is higher than that of the first minimum level of eligibility, the second set of financing options including terms for mitigating risk;
in response to receiving a request from the at least one provider entity for a financing arrangement that includes the first set of financing options, performing an eligibility determination for a requester to ascertain which of the minimum levels of eligibility, if any, applies to the requester; and
providing a response to the requester via the at least one provider entity based upon results of the eligibility determination that includes one of:
approving the request for the financing arrangement that includes the first set of financing options;
offering the requester other financing arrangement that includes the second set of financing options; and
declining the request.

9. The system of claim 8, wherein the credit application further performs:
in response to receiving an acceptance from the requester of one of the financing arrangement that includes the first set of financing options and the other financing arrangement that includes the second set of financing options:
verifying that an account with a borrower institution exists for the requester;
verifying that adequate funds exist in the account to cover a down payment;
verifying that outstanding drafts with insufficient funds on the account do not exist;
verifying that checking account information entered during setup is correct; and
notifying a lending institution providing the financing arrangement of the terms of the financing arrangement.

10. The system of claim 8, wherein the first set of financing options includes at least one of:
a revolving line of credit;
an installment repayment plan;
a no interest payment plan;
a low interest payment plan;
no down payment; and
an extended payment plan.

11. The system of claim 8, wherein the second set of financing options includes at least one of:
a minimum down payment;
a limited term payment plan;
an interest rate that is higher than an interest rate offered for the first set of financing options;
a payment plan that requires payments made by automatic electronic funds transfer; and
a payment plan that requires payments made by automatic generation of monthly drafts through means other than electronic funds transfer.

12. The system of claim 8, wherein the eligibility determination is based upon at least one of:
credit bureau score;
a cost of a product or service for which financing is requested; and
demographic information.

13. The system of claim 8, wherein the request is declined upon a determination of at least one of:
credit bureau score;
a cost of a product or service for which financing is requested;
demographic information;
the eligibility determination indicates the requester is deceased;
no financial information is found for the requester; and
the requester has filed for bankruptcy.

14. The system of claim 8, wherein the performing an eligibility determination includes performing a second level screening if the requester is not eligible for the first set of financing options upon completion of a first level screening.

15. A computer program product for providing credit services, the computer program product including instructions for executing a method, the method comprising:
establishing a first minimum level of eligibility for a first set of financing options;
establishing a second minimum level of eligibility for a second set of financing options, the second minimum level of eligibility correlated to a risk that is higher than that of the first minimum level of eligibility, the second set of financing options including terms for mitigating risk;
in response to receiving a request for a financing arrangement that includes the first set of financing options, performing an eligibility determination for a requester to ascertain which of the minimum levels of eligibility, if any, applies to the requester; and
providing a response to the requester based upon results of the eligibility determination that includes one of:
approving the request for the financing arrangement that includes the first set of financing options;
offering the requester an other financing arrangement that includes the second set of financing options; and
declining the request.

16. The computer program product of claim 15, further comprising instructions for implementing:
in response to receiving an acceptance from the requester of one of the financing arrangement that includes the first set of financing options and the other financing arrangement that includes the second set of financing options:
verifying that an account with a borrower institution exists for the requester;
verifying that adequate funds exist in the account to cover a down payment;
verifying that outstanding drafts with insufficient funds on the account do not exist;
verifying that checking account information entered during setup is correct; and
notifying a lending institution providing the financing arrangement of the terms of the financing arrangement.

17. The computer program product of claim 15, wherein the first set of financing options includes at least one of:
a revolving line of credit;
an installment repayment plan;
a no interest payment plan;
a low interest payment plan;
no down payment; and
an extended payment plan.

18. The computer program product of claim 15, wherein the second set of financing options includes at least one of:
a minimum down payment;
a limited term payment plan;
an interest rate that is higher than an interest rate offered for the first set of financing options;
a payment plan that requires payments made by automatic electronic funds transfer; and
a payment plan that requires payments made by automatic generation of monthly drafts through means other than electronic funds transfer.

19. The computer program product of claim 15, wherein the eligibility determination is based upon at least one of:
credit bureau score;
a cost of a product or service for which financing is requested; and
demographic information.

20. The computer program product of claim 15, wherein the performing an eligibility determination includes performing a second level screening if the requester is not eligible for the first set of financing options upon completion of a first level screening.
